(19) United States
(12) Patent Application Publication
(10) Pub. No.: US 2014/0116906 A1
(43) Pub. Date: May 1, 2014

(54) Sachet Containing a Liquid Medication

(71) Applicant: The Procter & Gamble Company, Cincinnati, OH (US)

(72) Inventors: Kurt Franklin Trombley, Loveland, OH (US); Kelly Lynn Morrison, South Lebanon, OH (US); David Edward Burbrink, Cold Springs, KY (US); Christopher Michael Komnenovich, Cincinnati, OH (US)

(73) Assignee: The Procter & Gamble Company, Cincinnati, OH (US)

(21) Appl. No.: 14/065,635

(22) Filed: Oct. 29, 2013

Related U.S. Application Data
(60) Provisional application No. 61/719,933, filed on Oct. 29, 2012.

(51) Int. Cl. A61J 1/10

(52) U.S. Cl. CPC A61J 1/10
USPC 206/438

(57) ABSTRACT

A resilient single-dose sachet for storage and administration of a liquid medication. The sachet includes a top portion, a bottom portion, and a perimeter, the top portion having a narrowed region; a front layer and a back layer. The front layer and back layer are permanently joined around the perimeter to form around the perimeter to form a seal and the seal forms a compartment. The compartment is adapted to contain the liquid medication. The sachet can be adapted such that the user can consume the liquid directly from the sachet.

### CROSS REFERENCE TO RELATED APPLICATION

This application claims the benefit of U.S. Provisional Application No. 61/719,933 filed Oct. 29, 2012.

### FIELD OF THE INVENTION

The present invention is directed towards sachets that contain a liquid medication, and more particularly, to child-resistant sachets that contains a single dose of liquid medication.

### BACKGROUND OF THE INVENTION

Liquid medications are typically packaged in large multi-dose bottles or other suitable packaging, often along with a measuring and/or dosing device. Because each dose must be measured prior to consumption, such packaging can make it burdensome to take liquid medications, especially when the user is not at home. Also, users can have difficulty determining the correct amount of medicine to take, which can cause them to inadvertently underdose or overdose. Instead, when away from home, some users may choose to take solid doses, such as capsules or tablets, when they would prefer a liquid medication.

Despite this need, products that provide a single dose of liquid medication are not widely available. These packages can be challenging to develop, as they must contain a full dose of liquid medication while still being small enough to be easily carried. However, users worry that the packages will not be strong enough to withstand everyday stress, such as being carried in a purse or pocket, which could cause the package to be punctured, rupture, or leak. Users also worry that when they open the package, liquid medication will spill or splash.

Furthermore, many liquid medications must be carried in a child-resistant package and child-resistant features generally require some combination of dexterity and strength to operate. Child resistant packages can be difficult to open and users often use scissors to open the package, particularly when the packages are small in size.

As such, there remains a need for a resilient, easy-to-open, child resistant sachet that contains a single dose of liquid medication and is small enough for a user to carry with them.

### SUMMARY OF THE INVENTION

A resilient single-dose sachet for storage and administration of a liquid medication, the sachet comprising: (a) a top portion, a bottom portion, and a perimeter, the top portion having a narrowed region and wherein the perimeter is curved; and (b) a front layer and a back layer, the front layer and back layer being permanently joined around the perimeter to form a seal, the seal forming a compartment wherein the compartment is adapted to contain the liquid medication and a headspace, wherein the sachet is being adapted such that the user can consume the liquid directly from the sachet.

A resilient single-dose sachet for storage and administration of a liquid medication, the sachet comprising: (a) a top portion, a bottom portion, and a perimeter, the top portion having a narrowed region and a tab; and (b) a front layer and a back layer, the front layer and back layer being permanently joined around the perimeter to form a seal, the seal forming a compartment wherein the compartment is adapted to contain the liquid medication and a headspace, wherein the sachet is being adapted such that the user can consume the liquid directly from the sachet and wherein the sachet is child-resistant.

### BRIEF DESCRIPTION OF THE DRAWINGS

While the specification concludes with claims particularly pointing out and distinctly claiming the subject matter of the present invention, it is believed that the invention can be more readily understood from the following description taken in connection with the accompanying drawings, in which:

FIG. 1 is a perspective view of a sachet;

FIG. 2 is a cross-sectional view of a sachet taken along section line 2-2 in FIG. 1;

FIG. 3 is a cross-sectional view of a sachet taken along section line 3-3 in FIG. 1;

FIG. 4 is a front view of the sachet; and

FIG. 5 is a schematic front view of a sachet with a sharp corner.

### DETAILED DESCRIPTION OF THE INVENTION

The present invention relates to a sachet that contains liquid medication. In one example, the sachet can contain a single dose of liquid medication and can be child resistant.

The sachet is portable and can be small enough to fit in a purse, briefcase, or pocket. The sachet can contain at least a single dose of liquid medication and in one example, the sachet can deliver a 15 to 20 mL dose of medication to the user.

Furthermore, the sachet can be resilient so the user does not have to worry about the sachet leaking, opening, spilling, or rupturing when it is carried or stored. In one example, the sachet does not rupture when carried in a purse, briefcase, or pocket. The sachet can be resilient enough so it can withstand areas of decreased pressure, such as high altitude regions (areas where the altitude is above 1,500 meters above sea level) and airplanes, that may be encountered during shipping, handling, or use. In another example, the sachet passes the altitude test. The Altitude Test is performed according to ASTM D3078 and the sachet is tested with the liquid medication. A package survives the Altitude Test if there are no leaks after the test is finished.

One aspect that can make the sachet more resilient is the seal, which must be strong enough to prevent leaking during shipping, handling, and use. One way to make the seal strong is to make it wider. In one example, the seal is at least 3 mm wide. However, if the seal is too wide, it will be difficult to tear the sachet open.

In another example, the sachet is made from a material that prevents the sachet from bursting, getting punctured, and helps maintain child resistance, which means that it is difficult for a child to tear or bite through the material during Child-Resistance Testing. In one example, the sachet remains intact following the Purse Test described hereafter.

Along with being strong, the sachet must be easy to open. For instance, if the seal is too wide, the sachet becomes difficult to tear open. In another example, the sachet can be opened without using scissors.

When users open a package that contains liquid medication, they are frequently worried about the product spilling. The headspace, and in particular the grasping region which is between the tear notch and the top of the liquid medication, is substantially free of liquid medication after the user has pushed the medication to the bottom portion or after the medication has been stored vertically for a period of time. The headspace and grasping region help prevent the liquid from splashing or spilling out of the sachet when it is opened. In one example, the grasping region can be 20-25 mm, which is approximately the width of a user's thumb.

The sachet can take no more than two steps to open and in one example, the sachet takes exactly two steps to open. First, the user can fold over the tab along the fold line and expose the tear notch. While holding the tab down, the user starts tearing at the tear notch and tears across the narrowed region of the sachet. When opening the sachet, the user's thumb and forefinger of the hand that is holding the tab rest on the grasping region.

After opening the sachet, the user can consume the liquid medication directly from the sachet. The narrowed region can act as a funnel or straw to help direct the liquid medication into the user's mouth. In one example, it takes no more than four squeezes to get a dose of liquid medication out of the sachet, in another example no more than three squeezes, in another example no more than two squeezes, and in another example no more than one squeeze. In another example, a separate measuring device is not needed. In another example, the narrowed region is tapered which further helps direct the liquid medicine into the user's mouth.

Although these sachets are easy to open, the sachets still meet the definition of child-resistant under the U.S. Poison Prevention Packaging Act of 1970 (16 C.F.R. §1700.14). Specifically, such sachets meet the definition of an F=2 package under the Poison Prevention Act. Specifically, such sachets meet the definition of an F=2 package under the Poison Prevention Act. In another example, the sachet can meet an F=1 package under the Poison Prevention Act, in another example an F=3 package, in another example an F=4 package, and in another example an F=8 package. In one example, the sachet alone meets the definition of child-resistant without the secondary packaging.

Overall, the sachet can help a user easily and discreetly take medication while away from home without making a mess. Furthermore, the user may also find the sachet useful while traveling due to its resiliency, compact size, and small amount of liquids. Some users may also prefer taking the sachets at home because they are premeasured, thereby eliminating the step of measuring the medication and the hassle of washing the measuring device.

As used herein, “child-resistant packaging” refers to packaging that is designed or constructed to be significantly difficult for young children to open or obtain a toxic or harmful amount of the substance contained therein within a reasonable time and not difficult for normal adults to use properly, but does not mean packaging which all such children cannot open or obtain a toxic or harmful amount within a reasonable time.

As used herein, “deliverable volume” refers to the volume of liquid that is transferred from the sachet. Deliverable volume can be conducted according to USP <698> Deliverable Volume for Single Unit Containers.

As used herein, “dwell time” refers to the amount of time the front layer and the back layer are held together when the seal is being made during manufacturing.

As used herein, “gained access to” refers to that liquid medication that has been removed or can be removed in whole or in part. Additionally, if the sachet is breached and the contents are not removed, this is still considered access.

As used herein, “headspace” refers to the area at the top of the sealed sachet. The amount of headspace can be measured after the liquid medication has been pushed to the bottom of the sachet. In one example, there is no gas or air in the headspace between the liquid and the top of the sealed sachet. In another example the headspace is filled with an inert gas, in another example with air.

As used herein, “indicia” provides information to a potential user of the liquid medication (e.g. the active contained therein) and sachets. The indicia can comprise many forms and present the information in many ways and in many types of media. Non-limiting examples of types of indicia include alpha-numeric indicia, pictures, drawings, illustrations, photographs, computer-produced images, colors, sounds, textures, shapes, symbols, letters, numbers, and combinations thereof.

As used herein, “joined” refers to configurations in which a first element is directly secured to a second element. Joined also includes configurations in which the first element is indirectly secured to the second element.

As used herein, “leak” refers to any opening in a sachet that, contrary to intention, either allows the inside atmosphere to freely escape or outside atmosphere to freely enter.

As used herein, “length” refers to the measure of the greatest dimension of the sachet.

As used herein, “medication” can refer to medications, such as pharmaceuticals, including prescription medications and/or over-the-counter medications, particularly medications that require child-resistant packaging. In some examples, a medication can be a supplement.

As used herein “thickness” refers to the greatest measure of the smallest dimension of the sachet. The “sachet thickness” refers to the greatest dimension between the front layer and the back layer and can be measured when the sachet is laying on the front layer or back layer on a level surface, without being manipulated, for at least five minutes. The sachet thickeness can be measured with a caliper.

As used herein, “permanently joined” refers to configurations in which a first element is secured to a second element such that the elements generally cannot be separated from one another without at least partially destroying one or both of the elements.

As used herein, “releasably joined” refers to configurations in which a first element is secured to a second element, such that the first element and the second element can be separated with no or minimal damage to the first and second elements.

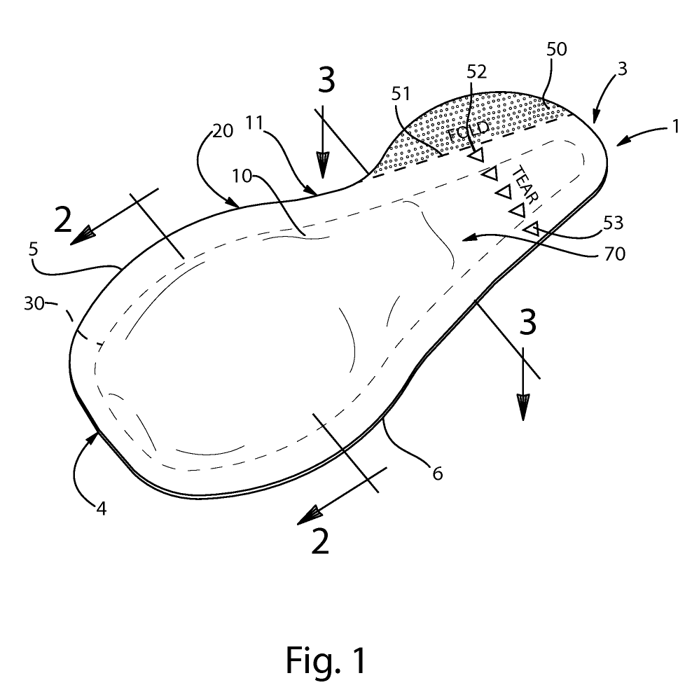

FIG. 1 is a perspective view of sachet 1 with top portion 3, bottom portion 4, left side 5, right side 6, and perimeter 11. The sachet can be made out of front layer 10 with front perimeter 11 and back layer 20 with back perimeter 21. Front perimeter 11 and back perimeter 21 are permanently joined at seal 30.

Sachet 1 comprises narrowed region 70 and the liquid medication can be dispensed through a portion of narrowed region 70. Narrowed region 70 begins where sachet 1 starts to narrow.

Sachet 1 also comprises tab 50. In one example, tab 50 can be attached to left side 5 and there are no sharp corners at the connection point. Instead the transition from left side 5 can be curved because radii have no stress concentration points commonly associated with corners. While not willing to be bound by theory, it is believed that if there is a sharp corner where the tab connects to the sachet, this can provide a place where the seal can rupture or where a child can gain access to the liquid medication inside the sachet by initiating a tear at the sharp corner. Having tab 50 on left side 5 can make it easier for a right handed user to open sachet 1, and the majority of users are right handed.

In order to open the sachet, a user folds tab 50, along fold line 51, to get access to tear notch 52. Then the user begins tearing at tear notch 52 and tears along tear indicia 53 across narrowed region 70 to gain access to the liquid medication. Tear notch 52 can be any shape or size that allows sachet 1 to be opened while maintaining child resistance. In one example, tear notch 51 cannot extend to the perimeter of tab 50 because it could allow children to more easily access the liquid medication. In one example, tear indicia 53 can be arrows or triangular arrowheads that direct the user where to tear.

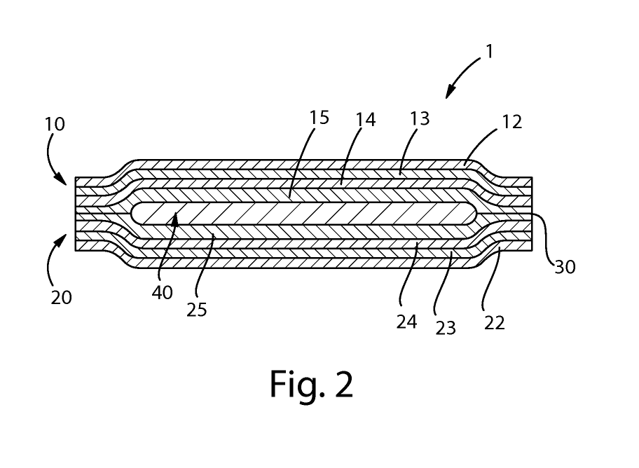

FIG. 2 is a cross-sectional view of sachet 1 along section line 2-2. In one example, front layer 10 and back layer 20 are made from a laminate material. Front layer 10 and back layer 20 can be made from the same laminate or a different laminate. The sachet can be made from any material that is resilient, child resistant, and easy to open. In one example, front layer 10 comprises front outer layer 12, front second layer 13, front third layer 14, and front inner layer 15 and back layer 20 comprises back outer layer 22, back second layer 23, back third layer 24, and back inner layer 25. In one example, front outer layer 12 and back outer layer 22 comprise polyethylene terephthalate (PET), front second layer 13 and back second layer 23 comprise orientated polyamide (OPA), front third layer 14 and back third layer 24 comprise aluminum, and front inner layer 15 and back inner layer 25 comprise polyethylene vinyl acetate (PE-EVA). In another example, front inner layer 15 and back inner layer 25 comprise linear low-density polyethylene (LLDPE) (exemplary laminates are commercially available from Amcor®, Mundelein, Ill.). In one example, each layer is attached to an adjacent layer with an adhesive. In another example, ink is between the front outer layer and the front second layer and/or back outer layer and back second layer.

Front layer 10 and back layer 20, and more specifically front inner layer 15 and back inner layer 25, can be permanently joined at seal 30 to form compartment 40.

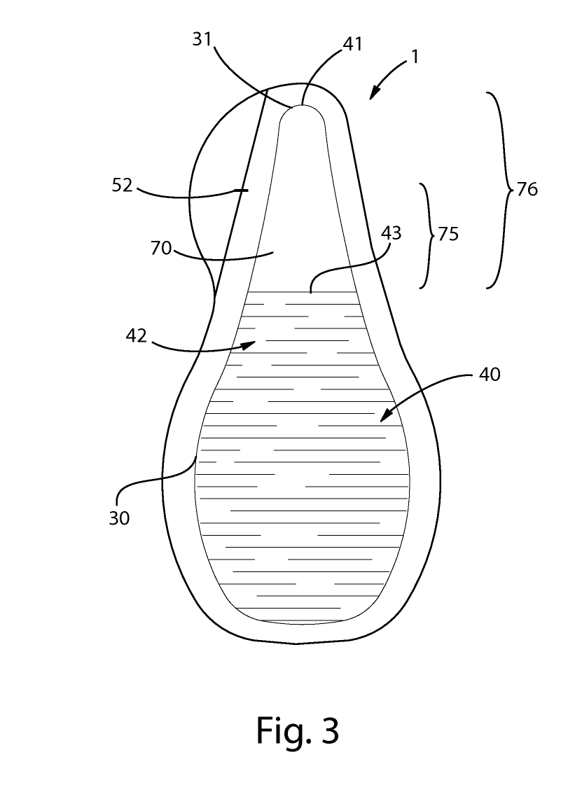

FIG. 3 is a cross-sectional view of sachet 1 along section line 3-3. Sachet 1 comprises seal 30. Seal 30 can be any width that allows for the sachet to be resilient as well as being easy to open. Seal 30 comprises seal inner edge 31.

Sachet 1 comprises compartment 40. Compartment 40 is formed by seal inner edge 31. Compartment 40 contains liquid medication 42. Liquid medication 42 comprises liquid medication top 43. Compartment 40 comprises compartment top 41.

In one example, narrowed region 70 comprises headspace 76. Headspace 76 is the area between compartment top 41 and top of liquid medication 43. Headspace 76 can comprise grasping region 75. Grasping region 75 is the area between tear notch 52 and top of liquid medication 43. Headspace 76, including grasping region 75, make it easier to open the sachet without spilling or splashing and creating a mess.

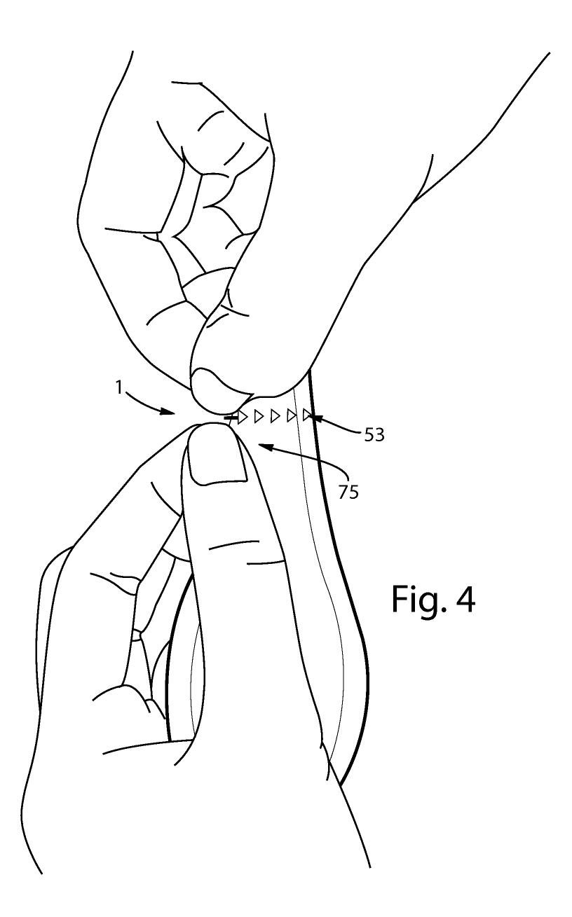

FIG. 4 is a front view of sachet 1. The hands show an exemplary hand position when the sachet is prepared to be opened. One hand holds sachet 1 by grasping region 75. The other hand tears across the top along tear indicia 53.

The sachet can be resilient, easy to open, and easily portable. In one example, the seal is created by putting a seal coating along the perimeter of the front inner layer and/or the back inner layer and then the front inner layer and the back layer are pressed together at a particular pressure and a particular temperature for a particular dwell time. The manufacturing conditions such as temperature, dwell time, and pressure can affect the seal strength. If the temperature is too high or too low then the front layer and the back layer may not form a strong seal. The pressure is applied during both a heating and a cooling cycle. If too little pressure is applied, then the front layer and the back layer do not bond well and the seal is too weak. If too much pressure is applied during heating and cooling, then the heat seal coating oozes out of the sealing area and there is not enough heat seal material to tightly bond the two surfaces together. Furthermore, if the dwell time is not long enough then the seal can be too weak and too long of a dwell time can deteriorate one or more of the layers including but not limited to the heat seal coating.

In one example, the sachets do not burst or leak when the compression force is 40 lbf (177.9 N), in another example 45 lbf (200.2 N), in another example 50 lbf (222.4 N), in another example 55 lbf (244.7 N), in another example 60 lbf (266.9 N), in another example 70 lbf (311.4 N), in another example 80 lbf (355.9 N), in another example 90 lbf (400.3 N), in another example 100 lbf (444.8 N), in another example 125 lbf (556.0 N), in another example 150 lbf (667.2 N), in another example 165 lbf (734.0 N) , in another example 175 lbf (778.4 N), in another example 200 lbf (889.6 N), and in another example 1509 lbf (6712.4 N). The compressive force is measured by the Seal Strength Compression Test described hereafter.

The sachet can be made out of any material that provides both the resiliency necessary to withstand shipping, handling, and use as well as be child resistant. Non-limiting examples of materials can include plastic, aluminum, aluminum alloys, other metals, paperboard, and combinations thereof. The sachet material can be any thickness. In one example, the sachet material thickness can be from 50 μm to 200 μm, in another example 60 μm to 180 μm, in another example 70 μm to 160 μm, in another example 75 μm to 150 μm, in another example 80 μm to 130 μm, in another example 85 μm to 110 μm, in another example 90 μm to 100 μm, and in another example 93 μm to 98 μm. In another example, the sachet material thickness can be from 85 μm to 115 μm, in another example from 90 μm to 105 μm, and in another example from 95 μm to 100 μm.

In one example, the sachet can be made out of a laminate material. In one example, the laminate comprises 2 layers, in another example 3 layers, in another example 4 layers, and in another example 5 layers. In one example, at least one of the layers of the laminate material comprises a plastic and the plastic laminate material can be 5 μm to 100 μm thick, in another example 10 μm to 50 μm thick, and in another example 20 μm to 30 μm thick. In another example, at least one of the layers of the laminate material comprises aluminum, aluminum alloy, or another metal and the layer can be 3 μm to 20 μm thick, in another example 5 μm to 15 μm thick, and in another example 7 μm to 12 μm thick.

In another example, the sachet can be opened so there is limited snagging or jerking motion when the user opens the sachet. A snagging or jerking motion can cause the liquid medication to splash out of the sachet, which is messy. The snagging or jerking motion can be quantified using the Pressure Profile Test described hereafter.

The seal can be any width. A wider seal can provide a more resilient package. However, wider seals increase the overall size of the package and are more difficult to open. If the seal is too wide, it can be difficult to open the package without scissors. In one example, the seal is 1 mm to 10 mm wide, in another example 2 mm to 8 mm wide, in another example 2 mm to 6 mm wide, in another example 3 mm to 5 mm wide, and in another example 3 mm to 4 mm wide.

The sachet can be any shape. The shape of the sachet can facilitate dispensing of the liquid medication. In one example, the bottom portion is convex. In another example, the bottom portion is shaped like an oval. In another example, the bottom portion is curved. In one example, the sachet comprises a region that is concaved. In another example, the perimeter comprises no sharp angles and in another example, the perimeter comprises no right angles. In another example, the sachet is teardrop shaped.

In another example, at least a portion of the perimeter is curved. As shown in FIG. 1, left side, right, and/or bottom side can be curved or have portions that are curved. In one example, at least about 25% of the perimeter is curved, in another example at least about 33%, in another example at least about 50%, in another example at least about 66%, in another example at least about 75% and in another example about 100% of the perimeter (or the entire perimeter) is curved.

The sachet can be any size and can comprise length, width, and depth. In one example, the sachet needs to be small enough that it can be conveniently carried in a purse, brief case, or pocket and still contain a dose of liquid medication.

The sachet can comprise a length. In one example, the sachet can have a length from 8 cm to 20 cm, in another example from 10 cm to 18 cm, in another example from 11 cm to 16 cm, in another example from 12 cm to 15 cm, in another example from 12.5 cm to 14.5 cm, in another example from 13 cm to 14 cm, and in another example from 13.5 cm to 14.5 cm. In one example, length can be 13.5 cm.

The sachet can comprise a sachet thickness. In one example, the sachet thickness is relatively small compared to the length, which allows it to be carried discreetly and comfortably in a user's pocket. Furthermore, thin sachets are easier to package in secondary containers and more sachets can be stored in a box. In one example, the sachet thickness is between 1 mm and 20 mm, in another example between 3 mm and 17 mm, in another example between 7 mm and 13 mm, and in another example between 9 mm and 11 mm. In another example, the sachet thickness is between 1 mm and 15 mm, in another example between 2 mm and 12 mm, in another example between 3 mm and 9 mm, and in another example between 4 mm and 6 mm. In one example, sachet thickness can be 5 mm. And in another example the sachet thickness can be 10 mm.

The sachet can comprise a maximum width. The maximum width is the greatest distance between the right side and the left side of the sachet. In one example, the maximum width can be in the bottom portion. In one example, the maximum width is from 3 cm to 10 cm, in another cm to 7.5 cm, in another example from 6 cm to 7.25 cm, in another example from 6.25 cm to 7 cm, and in another example from 6.5 cm to 6.75 cm. In one example, the maximum width is 6.7 cm.

In one example, the narrowed region is tapered, which means that the narrowed region becomes smaller and narrower towards one end, for instance the narrowed region can become narrower towards the top of the package. In one example, the narrowed region can have a slope of 0.1 to 2, in another example 0.25 to 1.5, and in another example 0.5 to 1.

In one example, the narrowed region is tapered and comprises a maximum width and a minimum width. In another example, the narrowed region is the same width throughout.

The user can consume the liquid medication directly from the sachet. In one example, the user can consume the medication from the consumption region, which can be the region in the top portion of the sachet that is open after the user tears across the top portion from the tear notch. The width of the consumption region can vary. However, if it is too small it can be difficult to get the medication out, especially if the liquid medication has a higher viscosity, and if it is too large it can be difficult and/or messy to consume the liquid medication directly from the sachet. In one example, the width of the consumption region is from 0.5 cm to 4 cm, in another example 1 cm to 3 cm, in another example 1.25 cm to 2.5 cm, in another example 1.5 cm to 2.25 cm, and in another example 1.75 cm to 2.0 cm.

The narrowed region can be any length. In one example the narrowed region is from 2 cm to 10 cm, in another example 3 cm to 8 cm, and in another example 4 cm to 6 cm. In one example, the narrowed region can be 5 cm long.

In one example, the width of the bottom portion is greater than the width of the narrowed region. In another example, the maximum width of the bottom portion is greater than the width of the narrowed region. In one example, the minimum width of the bottom portion is less than or equal to the maximum width of the narrowed region.

In one example, the ratio of the maximum width of the bottom portion to the maximum width of the narrowed region is 2:1 to 7:1, in another example from 3:1 to 6:1, in another example from 3.5:1 to 5:1, in another example from 3.8:1 to 4.75:1, in another example 4:1 to 4.5:1, and in another example 4.1:1 to 4.3:1. In another example, the ratio of maximum width of the bottom portion to minimum width of the narrowed region is 8:1 to 17:1, in another example 10:1 to 15:1, in another example 11:1 to 14.5:1, in another example 11.5:1 to 14:1, in another example 12:1 to 13:1, and in another example 12.5:1 to 13:1, and in another example 12.7:1 to 12.9:1

The tab can be any size. In one example, the tab can be large enough for a user to easily open the sachet. If the tab is too small, it makes it difficult to open the sachet, especially if the sachet is child resistant. However, if the tab is too large it can be difficult for the user to tear across the narrowed region. In one example, the tab has a width of 0.5 cm to 3 cm, in another example from 0.75 cm to 2 cm, in another example from 1 cm to 1.5 cm, and in another example from 1.2 cm to 1.4 cm. In one example, the tab has a width of 1.3 cm. In one example, the tab has a length of 1 cm to 10 cm, in another example from 2 cm to 8 cm, in another example 3 cm to 7 cm, and in another example 4 cm to 6 cm. In one example, the tab can have a length of 5.1 cm. In another example the length of the tab is 25% to 60% the length of the sachet, in another example 30% to 50%, in another example 32% to 42%, and in another example 35% to 39%.

The tab can be located on any portion of the sachet. In one example the tab is on the left side of the sachet, in another example the right side, and in another example the top. In one example, the sachet comprises two tabs. In another example, the sachet comprises two tabs and one tab is located on the right side and the other tab is located on the left side and the tabs are across from each other.

In one example, the tab is located on the left side or the right side of the narrowed region. In one example, the tab can be located at the bottom of the narrowed region, in another example the tab can be located in the middle of the narrowed region, and in another example the tab can be located at the top of the narrowed region.

The tear notch can be any size. However, if the tear notch is not long enough, then it can be more difficult for users to open the sachet. It can also be more difficult to manufacture the sachet because in order for users to be able to open a sachet with a small tear notch, the tear notch needs to be precisely along the fold line. However, if the tear notch is too large, the sachet may not be child resistant. In one example, the tear notch can be a horizontal slit. In another example, the tear notch can be a cut out, for instance a cut out diamond or circle. In one example, the tear notch can be from 2 mm to 12 mm long, in another example from 3 mm to 8 mm, and in another example from 4 mm to 7 mm wide. In one example, the tear notch can be 5 mm wide. In another example, the tear notch can be 7 mm wide.

In one example, the length of the grasping region is approximately equal to the width of a user's thumb, which makes it easier to open the sachet since a user can rest her thumb and possibly her forefinger on the grasping region while tearing the sachet open. In one example, the grasping region is from 0.75 cm to 5 cm long, in another example 1.25 cm to 4 cm, in another example 1.5 cm to 3.75 cm, in another example 1.75 cm to 3.25 cm, and in another example 2 cm to 2.75 cm. In one example, the grasping region is 2.5 cm long.

In one example, the material in the headspace region can be textured, which can help the user grip the sachet while she is opening it. The texture can be any texture. Non-limiting examples of texture can include ridges, sandy texture, raised bumps, grooves, and combinations thereof. In one example, only the grasping region can be textured. In another example, the area on either side of the tear notch can be textured. In one example, the region above the tear notch can be textured. In another example, the tab can be textured.

In one example, the tab can be a contrasting color to the narrowed region. While not willing to be bound by theory, if the tab is a contrasting color it can make opening the sachet more intuitive and reduce the amount of instructions that are needed to pass the senior friendly portion of the child resistance testing.

In one example, the tear indicia can be a contrasting color to the narrowed region. While not willing to be bound by theory, the tear indicia can make opening the sachet more intuitive by directing the user where to tear. In one example, the tear indicia can be across the narrowed region. In another example, the tear indicia can be on a portion of the narrowed region.

In one example, a combination of numbers, words, and graphics can be used to instruct the user on how to open the sachet. In one example, all of the instructions that are necessary to open the sachet are on the front layer or the back layer and there are no opening instructions on the secondary packaging. In another example, all of the instructions that are necessary to open the sachet are on the front layer of the sachet. In one example, the instructions to open the sachet comprise fewer than 25 words, in another example fewer than 20 words, in another example fewer than 15 words, in another example fewer than 10 words, in another example fewer than 8 words, in another example fewer than 5 words, in another example fewer than 3 words. In one example, the instructions for opening the sachet comprise two words. In one example, there are no opening instructions on the secondary package.

The sachet can also comprise regulatory information. In one example, all of the regulatory information can be on the sachet, which allows the sachet to be sold as a standalone product or in secondary package that contains no regulatory information in the United States as well as other geographies.

In another example the child-resistant feature is destroyed while opening the sachet in such a manner that the sachet cannot be refilled and re-used while retaining a functioning child resistant feature.

In one example, the sachet can be made more hygienic by adding a hygienic feature. One example, of a hygienic feature is folding the narrowed region or top portion over, for instance, folding the narrowed region or top portion at a point in the headspace and securing it with a sticker or other adhesive. In another example, the narrowed region or top portion is not folded over and something is placed over the top, for instance a sticker, plastic, or paper. Some users may want a sachet with a hygienic feature because the liquid medication is taken directly out of the sachet. Also, some users may prefer the hygienic feature because they intend to leave the sachet in their purse, desk drawer, wallet, or elsewhere to use as needed and therefore, the sachet might be stored outside its secondary container for a period of time before use.

Any liquid medication can be stored in the sachet. In one example, the liquid medication can be consumed by adults and children 12 years and over. Non-limiting examples of liquid medications can include multi-symptom relief cold-flu medication (e.g. Vicks® NyQuil® Cold & Flu Relief or Vicks® DayQuil® Cold & Flu Relief), cough medicine (e.g. Vicks® NyQuil® Cough or Vicks® Formula 44® Custom Care™ Dry Cough Suppressant), nighttime sleep aid (e.g. Vicks® ZzzQuil™), stomach relief medicine (e.g. Pepto-Bismol®). In one example, additives and/or surface treatments, such as the corona treatment, can be added to the liquid medicine and/or sachet to increase or decrease the surface tension of the liquid pharmaceutical which can achieve a lower amount of product adhesion.

In one example, the liquid medication can be a Newtonian fluid. In another example, the liquid medication can be a non-Newtonian fluid. In one example the liquid medication can have a viscosity from 1 to 10,000 cps, in another example 10 cps to 5,000 cps, in another example 50 cps to 2,000 cps, in another example 100 cps to 1000 cps, in another example 125 cps to 500 cps, in another example 150 cps to 250 cps. Viscosity can be measure by the Viscosity Test Method described hereafter.

The sachets can comprise any volume of liquid medication. The total volume of liquid medication can be varied based on the viscosity of the liquid medication. The higher the viscosity, the more liquid medication that needs to be put into the sachet in order to deliver a single dose of medication.

Users can be overwhelmed and may be hesitant to take liquid medication if the volume of liquid medication is too large. However, if the volume of the liquid medication in the sachet is too small, it will be difficult to formulate a liquid medication that can deliver a full dose of medication, while still having an acceptable taste to the user.

In one example, the sachet can comprise a deliverable volume of a single dose of liquid medication. In another example, the sachet can comprise a deliverable volume of from 5 mL to 60 mL of liquid medication, in another example from 8 mL to 40 mL, in another example from 10 mL to 30 mL, in another example from 11 mL to 25 mL, in another example from 12 mL to 22 mL, and in another example from 13 mL to 17 mL. In one example, the sachet can comprise a deliverable volume of 15 mL of liquid medication and in another example, the sachet can comprise a deliverable volume of 20 mL of liquid medication. In one example, the sachet can comprise a deliverable volume of less than 60 mL of liquid medication, in another example less than 50 mL, in another example less than 40 mL, in another example less than 30 mL, in another example less than 20 mL, in another example less than 18 mL, and in another example less than 16 mL.

### EXAMPLE

This Example shows the results from the Pilot Child-Resistant Screening Test when different aspects of the sachet such as tab shape and the material of the first and second layers were tested. The Pilot Child-Resistant Screening Test is described hereafter.

Test 1: The sachet comprised a front layer and the back layer that were made out of a laminate comprising 23 μm polyethylene terephthalate (PET), 18 μm foil, and 25 μm polyethylene (PE). Table 1 shows the results of Test 1.

TABLE 1

| | Amount of Time to |
|---|---|
| | Access First Dose |
| Child | (seconds) |
| 1 | 30 |
| 2 | n/a |
| 3 | n/a |
| 4 | n/a |
| 5 | n/a |
| 6 | n/a |
| 7 | n/a |
| 8 | 84 |

Since two children were able to access the first dose in less than five minutes, it was determined that more resilient material was needed.

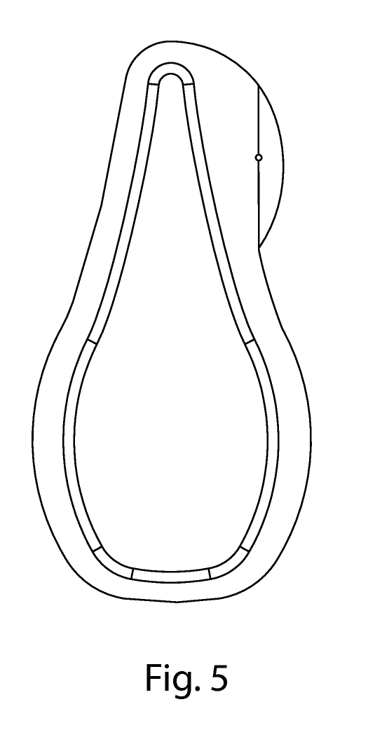

Test 2: The sachet included a tab that was attached to the narrowed region at a sharp corner, as shown in FIG. 5. The front layer and back layer of the sachet was constructed from a laminate comprising PET, OPA, aluminum, and PE-EVA (commercially available from Amcor®, Mundelein, Ill.). Table 2 shows the results of Test 2.

TABLE 2

| | Amount of Time to |
|---|---|
| | Access First Dose |
| Child | (minutes) |
| 1 | 7:22 |
| 2 | n/a |
| 3 | 6:25 |
| 4 | n/a |
| 5 | 6:00 |
| 6 | 6:44 |
| 7 | n/a |
| 8 | n/a |
| 9 | n/a |
| 10 | n/a |
| 11 | n/a |
| 12 | n/a |
| 13 | n/a |
| 14 | n/a |
| 15 | n/a |
| 16 | n/a |

All four of the children who were able to open the sachet, and each child who opened the sachet accessed the liquid medication by tearing at the stress concentration point under the tab. Since 25% (4/16) of children in this test accessed the liquid medication, it was determined that a new shape should be used to prevent the children from tearing at the stress concentration point under the tab.

However, a stronger material was used to make the sachets, than in Test 1, and none of the children were able to access the contents by biting through the laminate, even though five children tried to open the container with their teeth.

Test 3: The sachets used in this test did not have the correct seal setting when they were made. Table 3 shows the results of Test 3.

TABLE 3

| | Amount of Time to | Amount of Time to |
|---|---|---|
| | Access First Dose | Access Second Dose |
| Child | (minutes) | (minutes) |
| 1 | 5:32 | n/a |
| 2 | n/a | n/a |
| 3 | 7:30 | n/a |
| 4 | 8:30 | n/a |
| 5 | 6:01 | 7:20 |
| 6 | n/a | n/a |
| 7 | n/a | n/a |
| 8 | n/a | n/a |
| 9 | n/a | n/a |
| 10 | 3:45 | 7:25 |
| 11 | 0:57 | n/a |
| 12 | n/a | n/a |
| 13 | 6:35 | n/a |
| 14 | 2:31 | n/a |
| 15 | 4:15 | 6:40 |
| 16 | 1:15 | 3:20 |
| 17 | n/a | n/a |
| 18 | n/a | n/a |
| 19 | n/a | n/a |
| 20 | n/a | n/a |
| 21 | n | n/a |
| 22 | n | n/a |
| 23 | 3:02 | 9:52 |
| 24 | n | n/a |
| 25 | n | n/a |
| 26 | n | n/a |
| 27 | 2:42 | 6:55 |
| 28 | 8:20 | n/a |

Since 21% (6/28) of children accessed two of the sachets. All other recorded failures, except one, were due to seals leaking. The seals tended to leak at the very top or the very bottom. It is believed that the leaking was caused by the pressure and the temperature being too low during manufacturing, which caused the seals to be weak and therefore rupture more easily. Only one sachet was accessed via biting at the seal.

Test 4: The sachet included a tab that was attached to the narrowed region at a rounded corner, similar to the sachet in FIG. 1. The front layer and back layer of the sachet were constructed from a laminate comprising PET, OPA, aluminum, and PE-EVA (commercially available from Amcor®, Mundelein, Ill.). The tear notch is 5 mm long. Table 4 shows the results of Test 4.

TABLE 4

| | Amount of Time to | Amount of Time to |
|---|---|---|
| | Access First Dose | Access Second Dose |
| Child | (minutes) | (minutes) |
| 1 | n/a | n/a |
| 2 | n/a | n/a |
| 3 | n/a | n/a |
| 4 | 3:01 | ** |
| 5 | n/a | n/a |
| 6 | n/a | n/a |
| 7 | 5:22 | n/a |
| 8 | 10:00 | n/a |
| 9 | n/a | n/a |
| 10 | 7:30 | n/a |
| 11 | n/a | n/a |
| 12 | n/a | n/a |
| 13 | n/a | n/a |
| 14 | n/a | n/a |
| 15 | n/a | n/a |
| 16 | n/a | n/a |
| 17 | 4:13 | 8:37 |
| 18 | 5:01 | 8:00 |
| 19 | n/a | n/a |
| 20 | n/a | n/a |
| 21 | n/a | n/a |
| 22 | 9:26 | n/a |
| 23 | n/a | n/a |
| 24 | n/a | n/a |
| 25 | n/a | n/a |
| 26 | n/a | n/a |

**Accessed second dose in less than ten minutes.

Since only 11.5% (3/26) of the children were able to open two sachets, there is an 88.5% pass rate for this test. The thicker material in combination with eliminating the sharp corner at the point where the tab connects to the sachet, can help the sachet pass the Pilot Child Resistant Screening Test.

Test 5A and 5B: The sachets for both Test 5A and 5B were the same as Test 4, except the sachets also included graphics that were intended to show an adult user how to open the package and the tear notches were different sizes. In Test 5A, the notch was 9 mm long. In Test 5B, the notch was 7 mm long. Table 5A shows the results of Test 5A and Table 5B shows the results of Test 5B.

TABLE 5A

| | Amount of Time to | Amount of Time to |
|---|---|---|
| | Access First Dose | Access Second Dose |
| Child | (minutes) | (minutes) |
| 1 | 4:09 | 4:56 |
| 2 | n/a | m/a |
| 3 | n/a | n/a |
| 4 | n/a | n/a |
| 5 | 8:02 | n/a |
| 6 | n/a | n/a |
| 7 | * | * |
| 8 | n/a | n/a |
| 9 | 6:26 | 7:55 |
| 10 | 3:55 | n/a |
| 11 | 6:12 | 6:59 |

*Child was registered to participate in panel but did not attend the testing.

In Test 5A, 27% (3/11) of children accessed two of the sachets. Some of the recorded failures were due to the child picking or biting at the tear notch.

TABLE 5B

| | Amount of Time to | Amount of Time to |
|---|---|---|
| | Access First Dose | Access Second Dose |
| Child | (minutes) | (minutes) |
| 12 | n/a | n/a |
| 13 | n/a | n/a |
| 14 | n/a | n/a |
| 15 | 2:45 | 3:17 |
| 16 | n/a | n/a |
| 17 | n/a | n/a |
| 18 | n/a | n/a |
| 19 | n/a | n/a |
| 20 | * | * |
| 21 | n/a | n/a |
| 22 | n/a | n/a |
| 23 | n/a | n/a |
| 24 | n/a | n/a |
| 25 | n/a | n/a |
| 26 | n/a | n/a |
| 27 | 8:44 | n/a |
| 28 | 10:00 | n/a |
| 29 | 3:58 | 9:32 |
| 30 | n/a | n/a |

*Child was registered to participate in panel but did not attend the testing.

In Test 5B, only 11.1% (2/18) of the children were able to open two sachets, there is an 88.9% pass rate for this test. Shortening the tear notch from 9 mm to 7 mm, can help the sachet pass the Pilot Child Resistant Screening Test. Furthermore, increasing the tear notch from 5 mm, as in Test 4, to 7 mm, had little impact on the child resistance of the package. A 7 mm tear notch may be advantageous because it may make it easier for adults, including seniors, to open the sachet.

### Test Methods

### Child-Resistant Testing

The child-resistant testing can be conducted according to the Code of Federal Regulations Title 16: Part 1700.

### Pilot Child-Resistant Screening Test

The Pilot Child-Resistant Screening Test can be conducted as follows:

For the Pilot Child-Resistant Screening Test the children are between 42-51 months of age. Both boys and girls are selected.

A test failure is defined as any child who opens or gains access to the number of individual units which constitute the amount that may produce serious personal injury or serious illness, during the full 10 minutes of testing. For the following experiments, the test was a failure if any child opened or otherwise gained access to the liquid medication inside two sachets during the full 10 minutes of testing. In order to pass the Pilot Child-Resistant Screening, more than 80% of children do not gain access to the sachet and the test pool has at least ten children. If it is clear that a sachet is going to fail the test, the test can be terminated early.

The children are tested two at a time. The two children are escorted to the test area and are seated so there is no physical barrier between the children and the tester. The tester will talk to the children to make them at ease. The children are not given the impression that they are in a race or a contest, they are not offered a reward, and they are not told that the test is a game or that it is fun. To begin the test the tester shall hand the children identical sachets and say “Please try and open this for me.” If the child refuses to participate after the test has started, the tester shall reassure the child and gently encourage the child to try. If the child continues to refuse, the tester shall ask the child to hold the sachet in his/her lap until the other child is finished. This pair of children shall not be eliminated from the results unless the refusing child disrupts the participation of the other child.

Each child will be given up to 5 minutes to open his/her sachet. The tester shall minimize conversations with the children as long as they continue to attempt to open their sachets. The tester shall not discourage the children verbally or with facial expressions. If a child gets frustrated or bored and stops trying to open his/her sachet, the tester shall reassure the child and gently encourage the child to keep trying. The children should be allowed freedom of movement to work on their sachets as long as the tester can watch both children (e.g. they can stand up, get down on the floor, or bang or pry the sachet). The children shall be allowed to talk to each other about opening the sachets and shall be allowed to watch each other try to open sachets. If the child opens his/her sachet, the tester shall say, “Thank you,” and take the sachet from the child.

At the end of the 5-minute period, the tester shall demonstrate how to open the sachet if either child has not opened his or her sachet. Prior to the beginning of the demonstration, the tester shall ask the children to set their sachets aside. The children shall not be allowed to continue to try to open their sachets during the demonstration period. The tester shall say, “watch me open my package.” Once the tester gets the children's full attention, the tester shall hold the demo sachet approximately two feet from the children and open the sachet at a normal speed as if the tester were going to use the contents. There shall be no exaggerated opening movements. The tester shall not discuss or describe how to open the sachet.

Then, the children are given a second five-minute period to try and open their sachets. The tester begins the five minute period by saying, “now you try to open your packages.” If both children have not used their teeth to try to open their sachets during the first 5 minutes, the tester shall say immediately before beginning the second 5-minute period, “You can use your teeth if you want to.” This is the only statement that the tester shall make about using teeth. The test shall continue for another five minutes or until both children have opened their sachets, whichever comes first.

### Pressure Profile Test

Set up the FingerTPS II Tactile Pressure Sensor (available from Pressure Profile Systems, Los Angeles, Calif.), according to the instructions provided by Pressure :Profile Systems The FingerTPS Il includes a laptop with Chameleon Software, sensors, wrist units, wireless dongle, cables, and a calibration pad.

Next, hook up the participant to the system using the wires that are included. with the FingerTPS IL Then, put the pressure glove on the panelist and connect to the wires. Latex or nitrile gloves or finger cots are placed on top of the pressure glove.

Then, the participant sits in resting position. Resting position is when the data output reflects no changes in pressure and the panelist sits with her thumbs point upwards with their hands resting on a table to establish a baseline observation.

The Chameleon software is opened and the software will automatically connect to the wireless sensors. Check the gloves to make sure that they are giving a good signal before beginning the test. A poor signal will have a lot of interference, when the participant is in the resting position which can be caused by a faulty sensor or by a poor connection between the wireless pack and the glove. If interference is visible then check connection and unplug and then replug the glove or switch the glove for a different on

Next, calibrate the system by selecting the Calibrate FingerTPS in the Chameleon software. Select both the right thumb and left thumb and a force load of 3000 g. The press BEGIN in the software, Slowly press down the thumb listed on the screen onto the calibration pad until a load of 3000 g is reached. Release quickly. This may need to be done multiple times per thumb to calibrate correctly. The software will indicate if a calibration point has been established or if not, it will provide recommendations on possible ways to modify approach to ensure a good reading.

After the system is calibrated, the data readings can begin. The panelist should remain in the resting position at all times when sachets are not being opened in order to keep the baseline accurate.

Next the panelist is given a sachet to open. The panelist should not handle the sachet with her thumbs, the thumbs should only be used when opening the package. The panelist will then be asked to open the sachet and she can use her thumbs to tear it open. After the package is opened the panelist should return to the resting position.

After opening the package the panelist is asked to rate the sachet on a scale of 140, 1=easiest to open, 10=hardest to open. Then, the panelist is asked if a snag is present. If the panelist asks for a definition of “snag” she should be told that a snag is defined as a holdup in a tear propagation that requires an addition application of pressure in order to complete the tear and have the material detach.

The test is repeated. Sachets with different seal widths can be tested and each seal width should be tested five times. If more than one seal width is tested, the sachets should be given to the panelist in a random order and the panelist should not be told that the sachets are different.

Once all of the sachets have been opened and the questions have been answered, the panelist should be asked what drove their rating scale (i.e. snag presence, snag magnitude, duration of tear, pressure application required, etc).

Then analyze the data to determine the snag magnitude and snag duration.

### Purse Test

The Purse Test is intended to simulate damage to a sachet over a 28 day period. The Purse Test can be performed as follows:

First, a small purse is loaded with the following items: keys, sunglasses, pen, pencil, $0.41 (one of each coin), lipstick, eye drops, ChapStick®, folded envelope, emery board. Repeat for second small purse. A small purse is a clutch-style ladies purse measuring no more than 12″ in length (ideally around 6″), 5″ in depth (ideally around 3″) and 7″ in height (ideally around 5″).

Next, a medium purse is loaded with the following items: keys, sunglasses, pen, pencil, $0.41 (one of each coin), lipstick, eye drops, ChapStick®, folded envelope, wallet, emery board, compact, small hairbrush. Repeat for second medium purse. A medium purse is a ladies purse measuring no more than 12″ in length (ideally around 9″), 7″ in depth (ideally around 5″) and 12″ in height (ideally around 9″). The medium purse must be larger in two dimensions than the small purse.

Then, large purse or briefcase is loaded with the following items: 1″ binder, file folders, umbrella, keys, sunglasses, pen, pencil, $0.41 (one of each coin), lipstick, eye drops, ChapStick®, folded envelope, wallet, emery board, compact, small hairbrush. Repeat for second large purse. A large purse is a ladies purse or a soft-sided briefcase measuring at least 12″ in length (ideally around 15″), 6″ in depth (ideally around 8″) and 12″ in height (ideally around 15″). The large must be larger in all dimensions than the small purse and larger in two dimensions than the medium purse.

Load one sachet into each of the small purses and load two sachets into each of the medium and large purses. Then, place the two large bags into a 12″×12″×12″ box and place the remaining bags into a 12″×12″×12″ box. The fit for both boxes should be snug.

Secure each box to the Model 1000-5 TTV2 Vibration Test System (available from Lansmont Corporation, Monterey, Calif.) using the test system restraints. Look for gaps on the table that are larger than the box and if there are large gaps, wrap each box with stretch wrap. The vibration test system should not be started until both boxes are secure.

The sweep pattern is set from 3-6 Hz, beginning at 5 Hz and the rate is set at 1.5 oct/min. The run is set for 224 sweeps, which takes approximately two hours and ten minutes to run. Set sweep pattern from 3-6 Hz, beginning at 5 Hz.

Then, touch the “start” button on the computer screen and allow the vibration test system to complete 224 sweeps. Then, remove the boxes from the table and evaluate according to project success criteria.

The sachet passes the Purse Test if the sachet remains intact, which means that the sachet does not rupture, leak, or get punctured.

### Seal Strength Compression Test

The Seal Strength Compression Test can be conducted as follows:

First, turn on the Instron® Model #5566 (available from Instron®, Norwood, Mass.) and load the B1ueHill™ 2 software (available from Instron®). The Instron® is set up with two flat plates. One plate is motorized and has a 10 kN load cell, which has an accuracy of +/−0.4% of scale, and the other plate remains stationary. /

The sachet is placed in a gallon size Ziplock® bag, excess air is removed, and then it is centered on the stationary Instron® plate. Then, the Instron® is set at a cross-head speed of 1 in/min. Then, the test begins and the motorized plate continues compressing the sachet until it bursts. When the sachet bursts, the test is stopped and the sachet is removed. The maximum data point is recorded as the peak. The test can be repeated with multiple sachets.

### Viscosity Test Method

The viscosity of the liquid medication can be measured using a digital :Brookfield Viscometer (model RVDVII) with a CPE-41 spindle with temperature control. The viscosity is measured at 25° C., with a 1 mm gap (distance between the rotating spindle and the wall of the RVDVII), at a shear rate of 1 RPM (rotations per minute). Each measurement is taken for a period of two minutes to allow for the collection of enough data points to determine the average viscosity of the product (i.e. the spindle rotates at 1 rpm for 2 minutes).

Values disclosed herein as ends of ranges are not to be understood as being strictly limited to the exact numerical values recited. Instead, unless otherwise specified, each numerical range is intended to mean both the recited values and any integers within the range. For example a range disclosed as “1 to 10” is intended to mean “1, 2, 3, 4, 5, 6, 7, 8, 9, 10.”

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A resilient single-dose sachet for storage and administration of a liquid medication, the sachet comprising:
a. a top portion, a bottom portion, and a perimeter, the top portion having a narrowed region and wherein the perimeter is curved; and
b. a front layer and a back layer, the front layer and back layer being permanently joined around the perimeter to form a seal, the seal forming a compartment wherein the compartment is adapted to contain the liquid medication and a headspace, wherein the sachet is being adapted such that the user can consume the liquid directly from the sachet.

2. The sachet of claim 1, wherein the narrowed region is tapered.

3. The sachet of claim 1, wherein the sachet comprises a deliverable volume of less than 20 mL of liquid medication.

4. The sachet of claim 1, wherein the headspace further comprises a grasping region and wherein the grasping region is about 1.5 cm to about 3.75 cm long.

5. The sachet of claim 1, wherein the seal is from about 2 to about 6 mm wide.

6. The sachet of claim 1, wherein the sachet is from about 10 cm to about 18 cm long.

7. The sachet of claim 1, wherein the sachet is from about 7 mm to about 13 mm deep.

8. The sachet of claim 1, wherein the sachet is child resistant.

9. A resilient single-dose sachet for storage and administration of a liquid medication, the sachet comprising:
a. a top portion, a bottom portion, and a perimeter, the top portion having a narrowed region and a tab; and
b. a front layer and a back layer, the front layer and back layer being permanently joined around the perimeter to form a seal, the seal forming a compartment wherein the compartment is adapted to contain the liquid medication and a headspace, wherein the sachet is being adapted such that the user can consume the liquid directly from the sachet and wherein the sachet is child-resistant.

10. The sachet of claim 9, wherein the tab has a tear notch.

11. The sachet of claim 10, wherein the tab has a fold line disposed such that the tear notch is accessed by folding the tab along the fold line.

12. The sachet of claim 10, wherein the liquid medication is accessed by tearing from the tear notch across the narrowed region.

13. The sachet of claim 9, wherein the compartment contains a headspace.

14. The sachet of claim 12, wherein the headspace further comprises a grasping region is provided such wherein the grasping region is substantially free of liquid during opening.

15. The sachet of claim 9, wherein the sachet comprises a deliverable volume of less than about 30 mL of liquid medication.

16. The sachet of claim 14, wherein the sachet comprises a deliverable volume of less than about 20 mL of liquid medication.

17. The sachet of claim 9, wherein a region of the perimeter is concave.

18. The sachet of claim 9, wherein a region of the perimeter is convex.

19. The sachet of claim 9, wherein the sachet is from about 10 cm to about 18 cm long.

20. The sachet of claim 9, wherein the sachet is from about 7 mm to about 13 mm deep.
